(19) United States
(12) Patent Application Publication
(10) Pub. No.: US 2019/0259068 A1
(43) Pub. Date: Aug. 22, 2019

(54) POINT-OF-PURCHASE ADVERTISING SYSTEM

(71) Applicant: TOSHIBA TEC KABUSHIKI KAISHA, Tokyo (JP)

(72) Inventors: Ryuichi AOYAMA, Mishima Shizuoka (JP); Tomonori IKUMI, Numazu Shizuoka (JP); Naoki WATANABE, Adachi Tokyo (JP); Masami TAKAHATA, Setagaya Tokyo (JP); Toshinori FUKUTA, Mishima Shizuoka (JP)

(21) Appl. No.: 16/275,880

(22) Filed: Feb. 14, 2019

(30) Foreign Application Priority Data
Feb. 16, 2018 (JP) 2018-025953

(51) Int. Cl. G06Q 30/02; G06Q 20/20

(52) U.S. Cl. CPC G06Q 30/0268; G06Q 20/202

(57) ABSTRACT

A point-of-purchase advertisement system includes a storage device, a user terminal, and a central server communicating with each other over a computer network. The storage device maintains a selling price master list. The user terminal includes a display screen and a processor that generates a point-of-purchase advertisement including a commodity and a display price. The central server includes a processor that detects identification information for the commodity in the point-of-purchase advertisement generated at the user terminal, detects the display price for the commodity in the point-of-purchase advertisement, extracts a selling price for the commodity from the selling price master list, compares the extracted selling price to the detected display price, and causes the display device of the user terminal to display a screen indicating that the display price and the selling price differ when the comparison so indicates and requesting additional user input before outputting the point-of-purchase advertisement.

### CROSS-REFERENCE TO RELATED APPLICATION

This application is based upon and claims the benefit of priority from Japanese Patent Application No. 2018-025953, filed on Feb. 16, 2018, the entire contents of which are incorporated herein by reference.

### FIELD

Embodiments described herein relate generally to a point-of-purchase advertising system.

### BACKGROUND

In recent years, a Point Of Purchase (POP) advertisement generating system utilizing templates has been developed. In this system, a template for a POP advertisement is initially displayed on a display of a digital assistant (information terminal) such as a personal computer or a smartphone. An operator of the information terminal inserts an image, a commodity name, a price, and the like for an item to be advertised into the template to prepare advertisement data for POP advertisement displays. The prepared advertisement data is then printed by a printing machine, such as a multifunction peripheral, connected to a server and thus the POP advertisement is generated.

In such an operation described above, if there is some time-interval between the preparation of the advertisement data and the printing, there may be changes in selling prices of the item being advertised. If the change of the selling price occurs, the printing of the incorrectly priced advertisement hardcopy is a waste of time and money because the actual selling price is not reflected on the printed advertisement hardcopy.

### DESCRIPTION OF THE DRAWINGS

FIG. 1 is a diagram illustrating a POP advertisement creating system.

FIG. 2 is a schematic diagram illustrating aspects of a data record for a commodity saved in a price master file.

FIG. 3 is a block diagram of a user terminal.

FIG. 4 is a block diagram of a POP server.

FIG. 5 is a schematic diagram illustrating aspects of programs respectively included in the user terminal and the POP server, and the cooperation between these programs.

FIG. 6 is a schematic diagram illustrating an example of POP data stored in a POP file.

FIG. 7 is a flowchart illustrating aspects of a processing executed by a processor of a user terminal after a command for permitting a POP output is received.

FIG. 8 is a flowchart illustrating aspects of a processing executed by a processor of a user terminal after a command for permitting the POP output is received.

FIG. 9 is a flowchart illustrating aspects of a processing executed by a processor of a POP server after a command for permitting a POP output is transmitted.

FIG. 10 is a flowchart illustrating aspects of a processing executed by a processor of a POP server after a command for permitting a POP output is transmitted.

FIG. 11 is a flowchart illustrating aspects of a processing executed by a processor of a POP server after a command for permitting a POP output is transmitted.

FIG. 12 is a flowchart illustrating aspects of a processing executed by a processor of a POP server after a command for permitting a POP output is transmitted.

FIG. 13 is a schematic diagram illustrating transitions of main screens displayed on a touch panel of a user terminal.

FIG. 14 is a schematic diagram illustrating transitions of main screens displayed on a touch panel of a user terminal including a warning image according to a second embodiment.

FIG. 15 is a flowchart illustrating aspects of a processing executed by a processor of a user terminal according to a second embodiment.

FIG. 16 is a flowchart illustrating aspects of a processing executed by a processor of a POP server according to a second embodiment.

### DETAILED DESCRIPTION

According to one embodiment, a point-of-purchase advertisement system includes a storage device, a user terminal, and a central server communicating with each other over a computer network. The storage device maintains a selling price master list including a selling price associated with a commodity identification code. The user terminal includes a display screen and a first processor configured to generate a point-of-purchase advertisement including a commodity and a display price. The central server includes a second processor that is configured to detect identification information for the commodity in the point-of-purchase advertisement generated at the user terminal, detect the display price for the commodity in the point-of-purchase advertisement, extract a selling price for the commodity from the selling price master list using the detected identification information for the commodity, compare the extracted selling price to the detected display price, and cause the display device of the user terminal to display a screen indicating the display price and selling price differ when the comparison so indicates and requesting additional user input before permitting output of the point-of-purchase advertisement to an advertisement output device.

Hereinafter, example embodiments of a data processing apparatus capable of preventing a medium on which a list price displayed thereon from being output if the is not the same as an actual selling price displayed price does not match the actual selling price are described with reference to the accompanying drawings. The present examples describe a case in which a POP server of a POP advertisement creating system utilizing a template functions as a data processing apparatus.

### First Embodiment

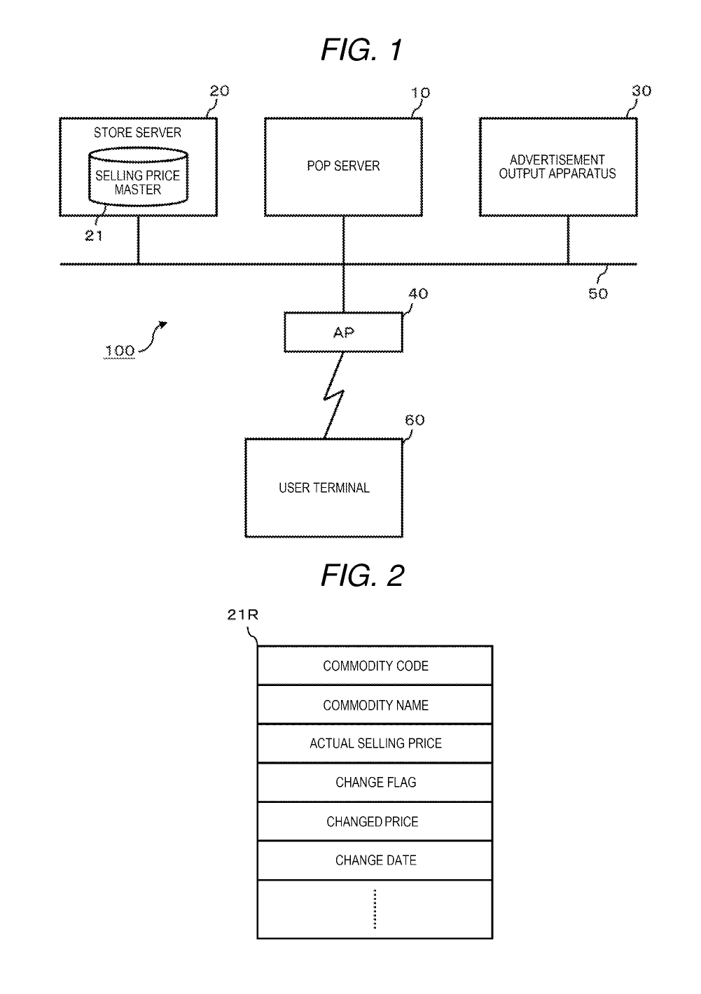

First, a first embodiment is described with reference to FIG. 1 to FIG. 13.

FIG. 1 is a diagram illustrating a POP advertisement creating system 100. The POP advertisement creating system 100 includes a POP server 10, a store server 20, an advertisement output apparatus 30, an access point 40, and a network 50. The POP advertisement creating system 100 further includes a user terminal 60 used by an operator who is in charge of creating a POP advertisement. The POP server 10, the store server 20, the advertisement output apparatus 30, and the access point 40 are respectively connected to the network 50.

The network 50 is a so-called LAN (Local Area Network) provided in a store. All or a part of the network 50 may be the Internet. For example, the POP server 10 may be a cloud-based system, and the POP server 10, the store server 20, the advertisement output apparatus 30, and the access point 40 may be connected via the Internet.

The access point 40 connects the user terminal 60 to the network 50 through a wireless LAN. In FIG. 1, only one user terminal 60 is illustrated, but the number of user terminals 60 is not limited to one. The access point 40 is capable of respectively connecting to several user terminals 60 operated by a plurality of users to the network 50.

The advertisement output apparatus 30 outputs the POP advertisements by for example printing on paper or other media. If the POP advertisement is to be presented as printed material, the advertisement output apparatus 30 can be a printer such as a multifunction peripheral. If the POP advertisement is to be presented as digital signage, the advertisement output apparatus 30 is a signage display or the like. In FIG. 1, only one advertisement output apparatus 30 is illustrated, but the number of advertisement output apparatuses 30 is not limited to one. Two or more advertisement output apparatuses 30, for example, multiple printers and/or multiple signage displays may be connected to the network 50.

The store server 20 is a computer for collectively managing data relating to the store. Although it is not shown in FIG. 1, a POS (Point Of Sales) terminal is typically connected to the store server 20. The store server 20 manages sales of the entire store by collecting and summing up sales data for each commodity which is registered in a sales transaction by a POS terminal. The store server 20 includes a price master file 21. The price master file 21 stores data relating to the present selling price of each commodity for sale in the store.

FIG. 2 is a schematic diagram illustrating a main portion of a data record 21R for one commodity stored in the price master file 21. As illustrated in FIG. 2, the data record 21R includes data items such as a commodity code, a commodity name, an actual selling price, a change flag, a changed price, and a change date. The commodity code is a code for uniquely identifying each commodity being sold at the store. In other words, the commodity code is identification information for the commodity. The commodity name is the name of the commodity associated with the commodity code in the same record (hereinafter referred to as a relevant commodity), and the actual selling price is a current (up-to-date) unit price of the commodity associated with the commodity code. The change flag is one-bit data for identifying whether or not a change in the actual selling price of the relevant commodity has been scheduled. In the first embodiment, the change flag is set to “1” if a change in the actual selling price is scheduled, and the change flag is set to “0” if a change has not been scheduled. The changed price and the change date respectively indicate the selling price after the change has been executed, and the change date is the date/time at which the price change is to be executed. Incidentally, the actual selling price in the data record 21R is updated to the changed price by the store server 20 once the date/time becomes the change date. At such time, the change flag in the data record 21R is switched to “0” from “1”, and the changed price and the change date are cleared by the store sever 20.

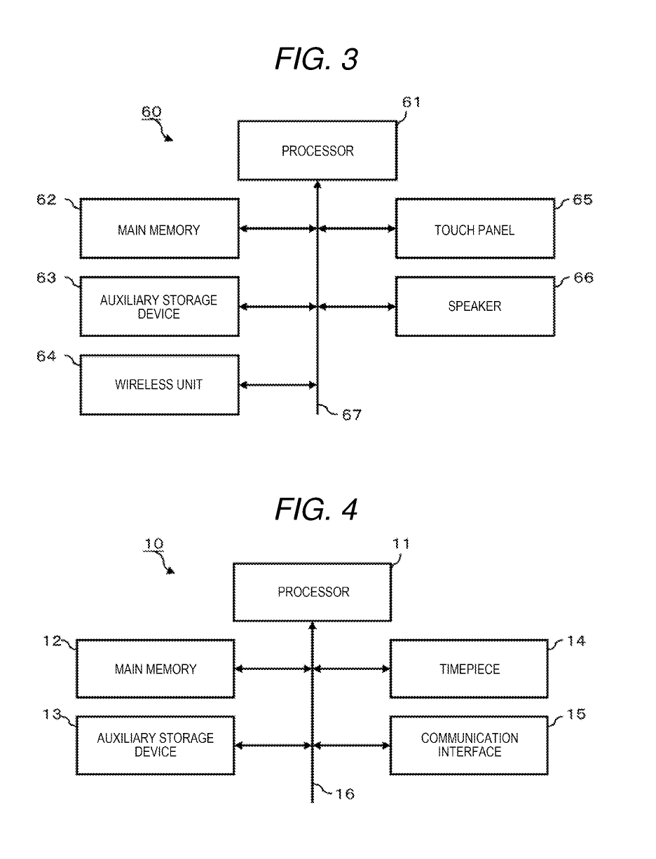

FIG. 3 is a block diagram illustrating a main circuit portion of the user terminal 60. The user terminal 60 includes a processor 61, a main memory 62, an auxiliary storage device 63, a wireless unit 64, a touch panel 65, a speaker 66, and a system transmission path 67. The system transmission path 67 includes an address bus, a data bus, a control signal line. The user terminal 60 connects the processor 61, the main memory 62, the auxiliary storage device 63, the wireless unit 64, the touch panel 65, and the speaker 66 to the system transmission path 67 directly or through a signal input-output circuit. In this manner, the user terminal 60 forms a computer composed of the processor 61, the main memory 62, the auxiliary storage device 63, and the system transmission path 67 which connects the processor 61, the main memory 62, and the auxiliary storage device 63 to each other.

The processor 61 acts as a central section of the computer described above. The processor 61 controls other components to realize various functions of a user terminal 60 in accordance with an operating system or an application program.

The main memory 62 acts as a main storage section of the computer described above. The main memory 62 includes a nonvolatile memory area and a volatile memory area. The main memory 62 stores the operating system and application programs in the nonvolatile memory area. The main memory 62 may store data in the nonvolatile memory area or the volatile memory area as necessary for the processor 61 to execute processing for controlling other components or units. The main memory 62 uses the volatile memory area as a work area in which data is suitably rewritten by the processor 61.

The auxiliary storage device 63 acts as an auxiliary storage section of the computer described above. For example, an electric erasable programmable read-only memory (EEPROM), a hard disc drive (HDD), a solid state drive (SSD), or the like is used as an auxiliary storage device 63. The auxiliary storage device 63 stores data used by the processor 61 to perform various processing, and data generated in the processing by the processor 61. The auxiliary storage device 63 may store the application program described above.

The wireless unit 64 performs transmission and reception of data by wireless in accordance with a predetermined wireless communication protocol between the wireless unit 64 and the access point 40.

The touch panel 65 acts as an input device and a display device of the user terminal 60. The speaker 66 is for outputting a voice, a warning sound, or the like.

For providing the functions of a user terminal 60 a smartphone, a tablet terminal, a laptop computer, or a desktop computer may be utilized. The user terminal 60 may be referred to as a digital assistant in some contexts.

FIG. 4 is a block diagram illustrating a main circuit portion of the POP server 10. The POP server 10 includes a processor 11, a main memory 12, an auxiliary storage device 13, a timepiece (clock) 14, a communication interface 15, and a system transmission path 16. The system transmission path 16 includes an address bus, a data bus, a control signal line. The POP server 10 connects the processor 11, the main memory 12, the auxiliary storage device 13, the timepiece 14, and the communication interface 15 to the system transmission path 16 directly or through a signal input-output circuit. In this manner, the POP server 10 forms a computer composed of the processor 11, the main memory 12, the auxiliary storage device 13, and the system transmission path 16 which connects the processor 11, the main memory 12, and the auxiliary storage device 13 to each other.

The processor 11 acts as a central section of the pop server 10. The processor 11 controls each component or unit to realize various functions of a POP server 10, in accordance with an operating system or an application program.

The main memory 12 acts as a main storage section of the computer described above. The main memory 12 includes a nonvolatile memory area and a volatile memory area. The main memory 12 stores the operating system and application programs in the nonvolatile memory area. The main memory 12 may store data in the nonvolatile memory area or the volatile memory areas as necessary for the processor 11 to execute processing. The main memory 12 uses the volatile memory area as a work area in which data is suitably rewritten by the processor 11.

The auxiliary storage device 13 acts as an auxiliary storage section of the pop server 10. For example, an EEPROM, an HDD, an SSD, or the like is used as an auxiliary storage device 13. The auxiliary storage device 13 stores data used by the processor 11 to perform various processing, and data generated in the processing by the processor 11. The auxiliary storage device 13 may store the application program described above.

The timepiece 14 functions as a time information source or system clock of the POP server 10. The processor 11 generates the current date and time based on the time information provided by the timepiece 14.

The communication interface 15 performs transmission and reception of the data in accordance with a predetermined communication protocol between the respective sections connected through the network 50.

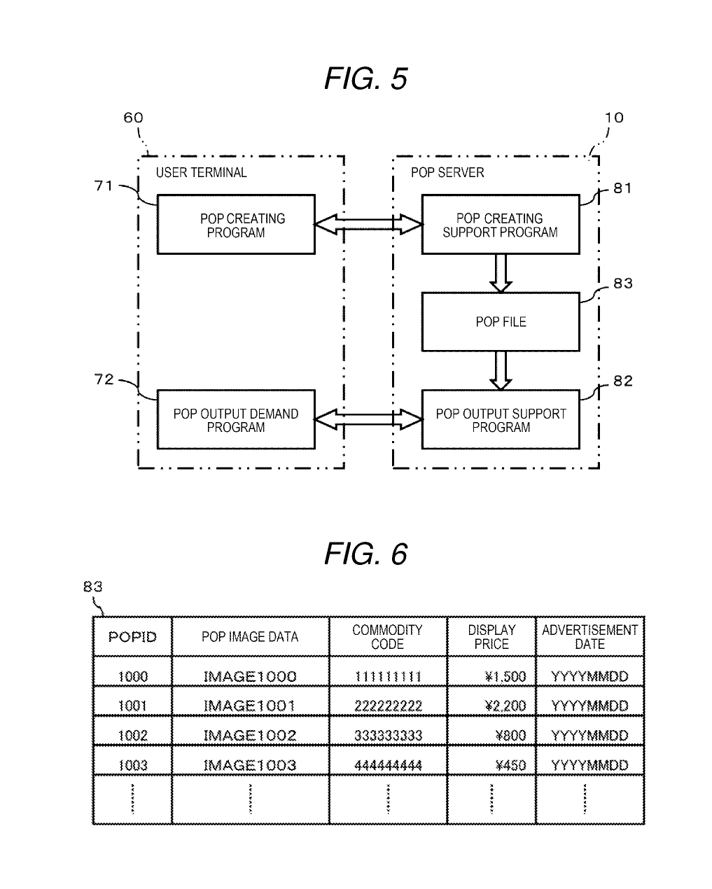

FIG. 5 is a schematic diagram illustrating particular programs respectively included in the user terminal 60 and the POP server 10, and a cooperation therebetween. As illustrated in FIG. 5, the user terminal 60 has a POP creating program 71 and a POP output demand program 72. The POP server 10 has a POP creating support program 81 and a POP output support program 82. The POP server 10 includes a POP file 83 for storing POP data, which may be referred to as display data of data to be displayed in some contexts. The POP server 10 sets the volatile area of the main memory 12 or a portion of an area of the auxiliary storage device 13 as an area of the POP file 83.

The POP creating program 71 and the POP creating support program 81 are used for creating the POP data on the user terminal 60. The created POP data is stored in the POP file 83. The POP output demand program 72 and the POP output support program 82 are used for selectively outputting the POP data previously stored in the POP file 83 to the advertisement output apparatus 30.

Hereinafter, an operation of the POP advertisement creating system 100 is described for a case in which the POP data for the POP advertisement is created by a user using the user terminal 60 and the user-created POP data is then output to the advertisement output apparatus 30. The basic operation for creating the POP data is the same as a standard POP advertisement creating system and, therefore, this operation is only briefly described.

The user operates the touch panel 65 of the user terminal 60 to select a POP creating job. Once the POP creating job is selected, the POP creating program 71 is activated in the user terminal 60. When the POP creating program 71 is activated, the processor 61 of the user terminal 60 establishes a communication link with the POP server 10 by controlling the wireless unit 64. If the communication link with the POP server 10 has already been established, the line establishment processing is skipped.

Once it is confirmed that the communication link with the POP server 10 is established, the processor 61 transmits a POP creating demand to the POP server 10. Thus, the POP server 10 activates the POP creating support program 81. When the POP creating support program 81 is activated, the processor 11 transmits a command permitting POP creating to the user terminal 60.

On the user terminal 60 which receives the command for permitting the POP creating, a POP creating screen is displayed on the touch panel 65 or the like. The POP creating screen is displayed in conjunction with the POP creating support program 81. Then, the user operates the POP creating screen to create a desired POP advertisement. For example, the user first selects a particular template for the POP advertisement. Next, the user inputs, into the fields of the selected template, an image, a commodity name, a price, and the like for a commodity/item being advertised. The price is the list price to be displayed on the POP advertisement as the selling price of the advertised commodity (target of the advertisement).

Upon completing the creation of the desired POP advertisement, the user operates the touch panel 65 to instruct the saving of the POP advertisement. In response to this instruction, the processor 61 transmits a POP advertisement saving demand to the POP server 10. The demand includes image data for the POP advertisement created through the POP creating screen.

The processor 11 receiving the POP advertisement saving demand generates the POP data by the operations of the POP creating support program 81. The POP data is formed by adding data items such as a POP ID, a commodity code, a list price, and an advertisement date to the image data for the POP advertisement, which is also referred to as the POP image data. The POP ID is a unique code assigned to the POP image data to differentiate the POP image data from any other pop image data. The commodity code is the identification information of the targeted commodity. The list price is inserted into the template as the selling price of the targeted commodity. The advertisement date is a scheduled date on which a display of a POP advertisement generated from the POP image data will be executed. The advertisement date is a date acquired from the user terminal 60 as designated by the user at the time of creating the POP advertisement, or can be a date (e.g., the current date) as acquired from the timepiece 14 if another date was not designated by the user at the time of creating the POP advertisement (or the POP image data thereof). The processor 11 saves the generated POP data in the POP file 83.

FIG. 6 is a schematic diagram illustrating an example of the POP data saved in the POP file 83. As illustrated in FIG. 6, in the POP file 83, the POP image data, the commodity code, the list price, and the advertisement date are saved in association with the POP ID.

The processor 11 saving the POP data in the POP file 83 notifies the user terminal 60 of the assigned POP ID for the POP data. The processor 61 transmitting the saving demand saves the POP ID as notified from the POP server 10 in a predetermined area of the auxiliary storage device 63. Thereupon, the operation of the POP advertisement creating system 100 in accordance with the POP creating program 71 and the POP creating support program 81 is ended.

Next, an operation at the time of outputting the POP data for printing or other display is described. The user operates the touch panel 65 of the user terminal 60 to select a POP output job. Once a POP output job is selected, the POP output demand program 72 is activated in the user terminal 60. Then, the processor 61 establishes the communication link with the POP server 10 by controlling the wireless unit 64. If the communication link with the POP server 10 is already established, the link establishment processing is skipped.

When it is confirmed that the communication link with the POP server 10 is established, the processor 61 transmits a POP output demand to the POP server 10. In the POP server 10 receiving the POP output demand, the POP output support program 82 is activated. Once the POP output support program 82 is activated, the processor 11 transmits a command permitting the POP output to the user terminal 60.

In the user terminal 60 receiving the command permitting the POP output, a POP output screen is displayed on the touch panel 65. The POP output screen is displayed in conjunction with the POP output support program 82. The user operates the POP output screen to instruct the output of the desired POP advertisement.

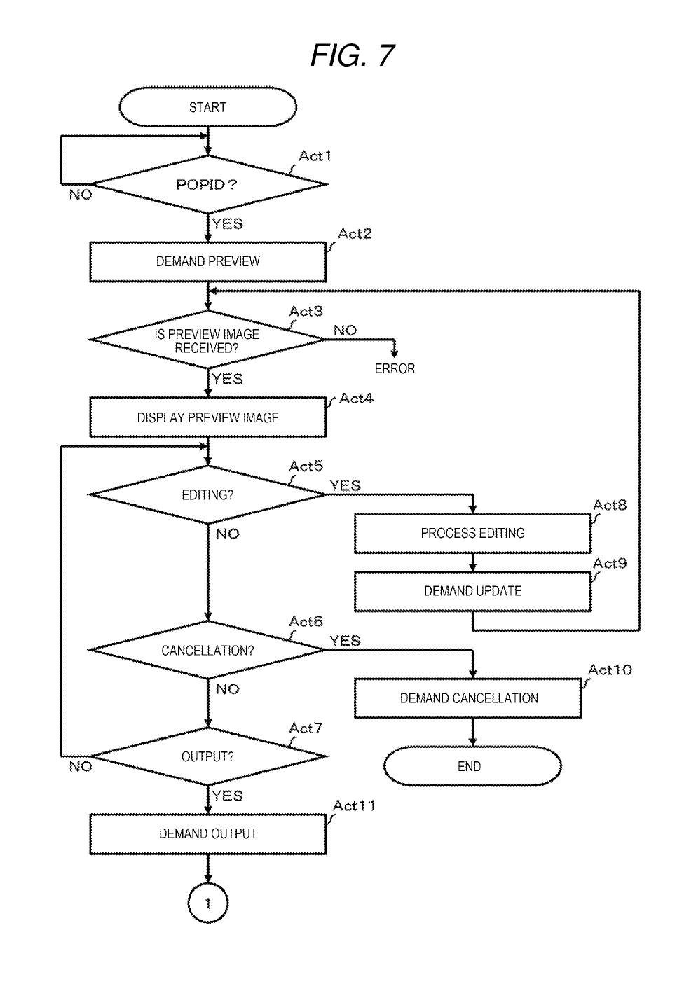

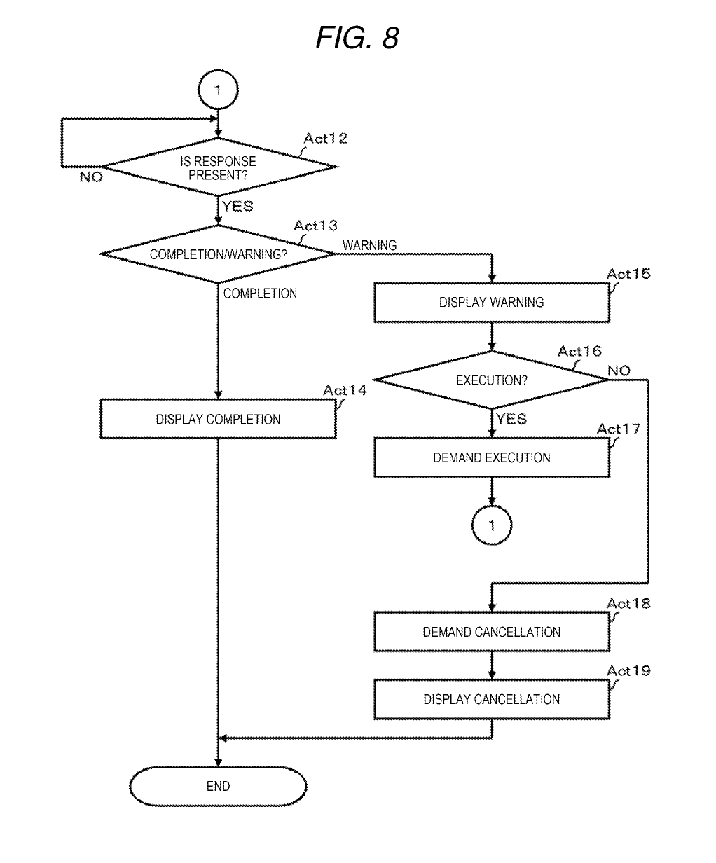

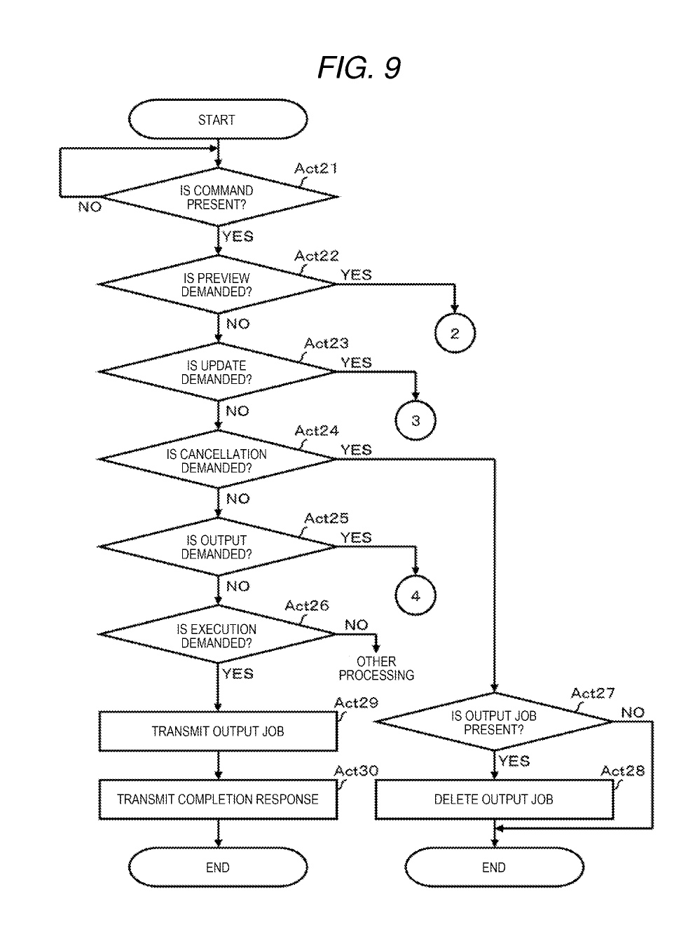

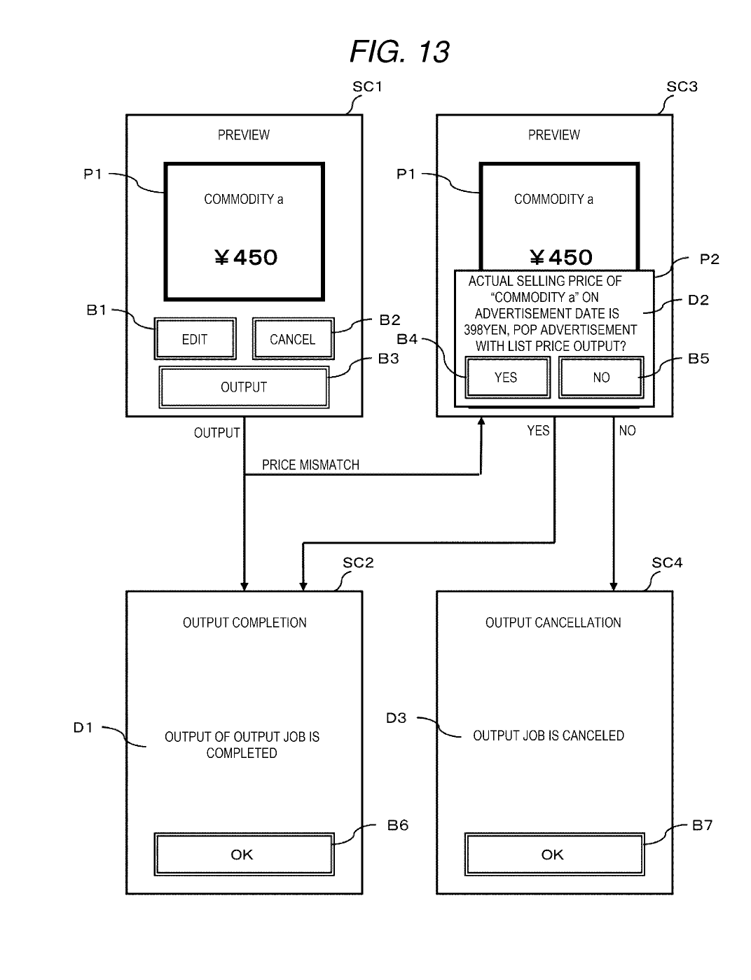

FIG. 7 and FIG. 8 are flowcharts illustrating a procedure of processing executed by the processor 61 after the command permitting the POP output has been received. FIG. 9 to FIG. 12 are flowcharts illustrating a procedure of processing executed by the processor 11 after the command permitting the POP output is received at the user terminal 60. FIG. 13 is a schematic diagram illustrating transitions of primary screens displayed on the touch panel 65. Hereinafter, the operation of the POP advertisement creating system 100 after the command permitting the POP output is received by the user terminal 60 is described with reference to FIG. 7 to FIG. 13. The content described hereinafter is an example and the present disclosure is not particularly limited to specific details of this example so long as the same results of the described operations as are achieved.

First, the user confirming the POP output screen designates the POP ID of the POP advertisement for which the output is being performed. Here, since a list of the POP IDs saved in the auxiliary storage device 63 can be displayed on the POP output screen, the user selects a desired POP ID from the displayed list. Alternatively, an input box for the POP ID can be displayed on the POP output screen, and the user may input the desired POP ID in the input box.

The processor 61 waits for designation of the POP ID (Act 1 in FIG. 7). Once the POP ID is designated by input to the POP output screen (YES in Act 1), the processor 61 controls the wireless unit 64 such that a preview demand is transmitted to the POP server 10. Thus, the preview demand is wirelessly transmitted to the POP server 10 from the wireless unit 64. The preview demand includes the designated POP ID. The preview demand wirelessly transmitted through the wireless unit 64 is received by the access point 40 and is further transmitted to the POP server 10 through the network 50.

The processor 11 awaits a command from the user terminal 60 (Act 21 in FIG. 9). If a command is received, the processor 11 confirms whether or not the command is a preview demand (Act 22). If the command is not a preview demand (NO in Act 22), the processor 11 confirms whether or not the command is an update demand (Act 23). If the command is not an update demand (NO in Act 23), the processor 11 further confirms whether or not the command is a cancellation demand (Act 24). If the command is not a cancellation demand (NO in Act 24), the processor 11 confirms whether or not the command is an output demand (Act 25). If the command is not an output demand (NO in Act 25), the processor 11 confirms whether or not the command is an execution demand (Act 26). If the command is not an execution demand (NO in Act 26), the processor 11 executes some other processing (e.g., processing not particularly relevant to the present embodiment) according to the command.

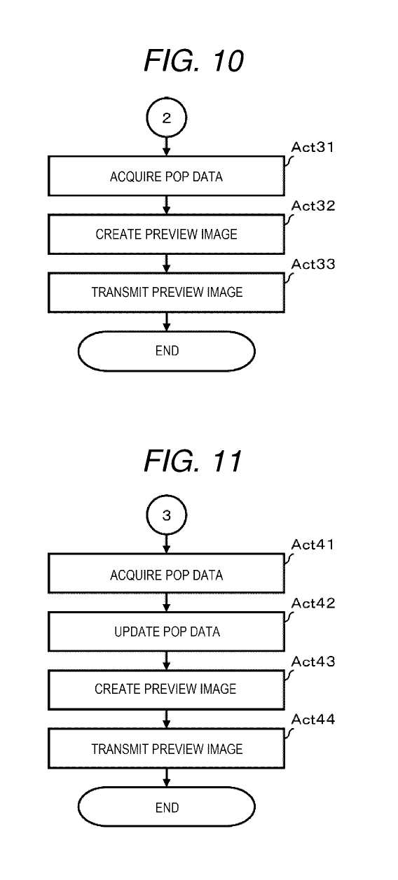

If the command for a preview demand is received from the user terminal 60 (YES in Act 22), the processor 11 executes the processing of the procedure illustrated in the flowchart of FIG. 10. The processor 11 retrieves the POP file 83 with the POP ID included in the preview demand, and acquires the POP data including the POP ID in Act 31. Next, the processor 11 generates preview image data for the POP advertisement based on the POP image data in Act 32. And then, the processor 11 controls the communication interface 15 such that the preview image data is transmitted to the user terminal 60 in Act 33. The preview image data is transmitted through the network 50 from the communication interface 15. The data is wirelessly transmitted to the user terminal 60 from the access point 40.

Referring to FIG. 7, the processor 61 in the user terminal 60 transmitting the preview demand command waits for the preview image data in Act 3. If the preview image data cannot be received due to an incorrect designation of the POP ID (NO in Act 3), the processor 61 ends the processing as an error.

If the preview image data is received from the POP server 10 (YES in Act 3), the processor 61 displays a preview image P1 (refer to FIG. 13) on the touch panel 65 according to the preview image data in Act 4.

FIG. 13 illustrates an example of a screen SC1 of the touch panel 65 on which the preview image P1 is displayed. As illustrated in FIG. 13, an edit button B1, a cancel button B2, and an output button B3 are also displayed on the screen SC1, along with the preview image P1 in which the commodity name “commodity a” and the list price “450 yen” are arranged in the template for the POP advertisement. The edit button B1 is used to instruct editing of the POP advertisement displayed in preview. For example, editing such as a change of the template, a change of the commodity name, or the change of the display price can be instructed. The cancel button B2 is used to instruct the cancellation of any output of the displayed POP advertisement. The output button B3 is used to instruct the output of the displayed POP advertisement.

Referring to FIG. 7, the processor 61 of the user terminal 60 displaying the preview image P1 confirms whether or not the edit button B1 has been selected in Act 5. If the edit button B1 is not selected (NO in Act 5), the processor 61 further confirms whether or not the cancel button B2 has been selected in Act 6. If the cancel button B2 is not selected (NO in Act 6), the processor 61 confirms whether or not the output button B3 has been selected in Act 7. If the output button B3 is not selected (NO in Act 7), the processor 61 returns to the processing in Act 5. The processor 61 waits for one of the edit button B1, the cancel button B2, and the output button B3 to be selected in Act 5 to Act 7.

In the waiting state (standby state) as described above, if it is detected that the edit button B1 is selected (YES in Act 5), the processor 61 executes an editing processing on the displayed POP advertisement. Specifically, the processor 61 displays a POP editing screen, similar to the POP creating screen, on the touch panel 65. On the POP editing screen, the image of the POP advertisement is displayed. The user manipulates the POP editing screen to edit the image of the POP advertisement in some manner. For example, the user changes the template being used for the POP advertisement. Alternatively, the user changes the commodity name or the list price. The user may also change the advertisement date.

In this manner, once the editing of the image of the POP advertisement is ended, the user operates the touch panel 65 to instruct an end of the editing. The processor 61 detects the instruction for ending the editing and controls the wireless unit 64 such that an update demand is transmitted to the POP server 10 (in Act 9). The update demand is wirelessly transmitted to the POP server 10 from the wireless unit 64. The update demand includes the image data of the POP advertisement as edited on the POP editing screen and the POP ID that was designated in Act 1. The update demand wirelessly transmitted through the wireless unit 64 is received with the access point 40, and is further transmitted to the POP server 10 through the network 50.

As described above, the processor 11 waits for a command from the user terminal 60 in Act 21 in FIG. 9. In this state, if the update demand is received from the user terminal 60 (YES in Act 23 in FIG. 9), the processor 11 executes the processing of the procedure illustrated in the flowchart of FIG. 11. The processor 11 retrieves the POP file 83 for the POP ID included in the update demand and acquires the POP data matching the POP ID in Act 41. Next, the processor 11 updates the POP data acquired from the POP file 83 based on the image data of the POP advertisement included with the update demand in Act 42. For example, if the POP image data was edited, the processor 11 updates the POP image data to the edited image data. If the commodity name and the list price is being edited, the processor 11 updates the commodity name and the list price of the POP data to the edited data. If the advertisement date is being edited, the processor 11 updates the advertisement date in the POP data to the edited date.

Once the update of the POP data has ended, the processor 11 creates preview image data for the POP advertisement based on the edited POP image data of the POP data in Act 43. After that, the processor 11 controls the communication interface 15 such that the preview image data is transmitted to the user terminal 60 in Act 44. The preview image data is transmitted through the network 50 from the communication interface 15. The data is wirelessly transmitted to the user terminal 60 from the access point 40.

Returning to FIG. 7, the processor 61 transmitting the update demand returns to the processing in Act 3. The processor 61 waits for the revised preview image data. When the preview image data is received from the POP server 10, the processor 61 displays the preview image P1 (refer to FIG. 13) on the touch panel 65 based on the received preview image data.

If it is detected that the cancel button B2 is selected in the waiting state of Act 5 to Act 7 (YES in Act 6), the processor 61 controls the wireless unit 64 such that the cancellation demand is transmitted in Act 10. The cancellation demand is wirelessly transmitted to the POP server 10 from the wireless unit 64. The c cancellation demand includes the POP ID. The cancellation demand wirelessly transmitted through the wireless unit 64 is received with the access point 40, and is further transmitted to the POP server 10 through the network 50.

If it is detected that the output button B3 is selected in the waiting state of Act 5 to Act 7 (YES in Act 7), the processor 61 controls the wireless unit 64 such that the output demand is transmitted in Act 11. The output demand is wirelessly transmitted to the POP server 10 from the wireless unit 64. The output demand includes the POP ID. The output demand wirelessly transmitted through the wireless unit 64 is received with the access point 40, and is further transmitted to the POP server 10 through the network 50.

As described above, the processor 11 waits for a command from the user terminal 60 in Act 21 in FIG. 9. If the cancellation demand is received from the user terminal 60 (YES in Act 24), the processor 11 determines whether or not an output job for the POP advertisement specified by the POP ID included in the cancellation demand is already stored in an output buffer in Act 27. The output buffer is formed in the volatile area of the main memory 12. If the output job is stored in the output buffer (YES in Act 27), the processor 11 deletes the output job from the output buffer in Act 28. If the output job is not stored in the output buffer (NO in Act 27), the processor 11 skips the processing in Act 28.

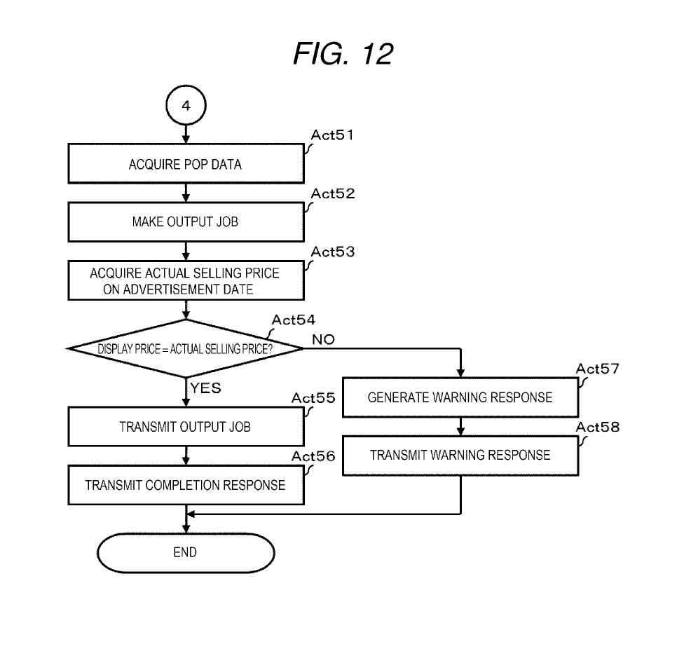

On the other hand, if the output demand is received from the user terminal 60 (YES in Act 25), the processor 11 executes the processing of the procedure illustrated in the flowchart of FIG. 12. The processor 11 retrieves the POP file 83 for the POP ID included in the output demand command and acquires the POP data associated with the POP ID in Act 51. Next, the processor 11 prepares an output job based on the POP image data and metadata included in the POP data in Act 52. The metadata is information necessary for the output of the POP advertisement. For example, if the advertisement output apparatus 30 is a printing machine, the metadata is a printer job language (PJL) information. The processor 11 stores the output job in the output buffer of the main memory 62.

The processor 11 retrieves/accesses the price master file 21 from the store server 20 to acquire the actual selling price on the advertisement date in Act 53. Specifically, the processor 11 retrieves/accesses the portion of the price master file 21 including the commodity code and for the specific advertisement date in the POP data. Then, the actual selling price or the changed price is acquired from the data record 21R including the commodity code. The actual selling price is acquired if the advertisement date is earlier than a change date on which the list price will be changed. On the other hand, the changed price is acquired if the advertisement date is on or later than the change date.

The processor 11 compares, in Act 54, the list price in the POP data with the actual selling price as acquired in the processing of Act 53. If the list price is equal to the acquired actual selling price (YES in Act 54), the processor 11 controls the communication interface 15 such that the output job is transmitted to the advertisement output apparatus 30 in Act 55. Then, the output job is transmitted to the advertisement output apparatus 30 through the network 50 from the communication interface 15.

In a case in which the advertisement output apparatus 30 is a printer, the printing of the output job is executed. As a result, the POP image data is printed on a POP paper or the like. If the advertisement output apparatus 30 is a signage display, display of the output job is executed. As a result, the POP image data is displayed on the signage display.

The processor 11 transmitting the output job controls the communication interface 15 such that a completion response is transmitted to the user terminal 60 in Act 56. Then, the completion response is transmitted through the network 50 from the communication interface 15. The completion response is wirelessly transmitted to the user terminal 60 from the access point 40.

On the other hand, if the list price is not the same as the actual selling price (NO in Act 54), the processor 11 generates a warning response command in Act 57. For example, in a case in which the POP advertisement of the commodity “commodity a” for which the price has changed to 380 yen from 450 yen on the advertisement date is to be created, the list price differs from the actual selling price on the date of the advertisement. The warning response command includes the information of the actual selling price (380 yen). The processor 11 controls the communication interface 15 to transmit the warning response command to the user terminal 60 in Act 58. The warning response command is transmitted through the network 50 from the communication interface 15. The warning response command is wirelessly transmitted to the user terminal 60 from the access point 40.

With reference to FIG. 8, processor 61 transmitting the output demand waits for a response signal in Act 12. If the response signal is received from the POP server 10 (YES in Act 12), the processor 11 identifies whether the response signal is a completion response or a warning response in Act 13.

If the response signal is a completion response (“COMPLETION” in Act 13), the processor 61 displays completion information D1 (refer to FIG. 13) on the touch panel 65 in Act 14.

FIG. 13 illustrates an example of a screen SC2 on the touch panel 65 on which the completion information D1 is displayed. As shown in FIG. 13, an OK button B6 is displayed along with the completion information D1 (“Output of output job is completed”) on the screen SC2. If the user confirms the completion information D1 by selecting (touching) the OK button B6, the information processing according to the POP output demand program 72 is ended.

Returning to FIG. 8, if the response signal from the POP server 10 is the warning response command (“WARNING” in Act 13), the processor 61 displays a warning image P2 (refer to FIG. 13) on the touch panel 65 in Act 15.

FIG. 13 illustrates an example of a screen SC3 on the touch panel 65 on which the warning image P2 is displayed. As shown in FIG. 13, the warning image P2 is displayed on the screen SC3 such that the warning image P2 does not overlap the preview image P1. In the warning image P2, a “Yes” button B4, and a “No” button B5 are displayed along with information D2 including the actual selling price (398 yen). If the user confirms the warning image P2 by selecting (touching) the “Yes” button B4 the POP advertisement with the list price (450 yen) on preview image P1 will be output. Otherwise, the user touches the “No” button B5 and the incorrectly priced POP advertisement will not be output.

Returning to FIG. 8, the processor 61 displaying the warning image P2 confirms whether or not the execution of the output has been instructed in Act 16. If it is detected that the “Yes” button B4 of the warning image P2 is selected, the processor 61 determines that the execution of the output is still instructed. If it is detected that the “No” button B5 is selected, the processor 61 determines that non-execution of the output has now been instructed.

If the execution of the output is instructed (YES in Act 16), the processor 61 controls the wireless unit 64 to transmit the execution demand to the POP server 10 in Act 17. The execution demand is wirelessly transmitted to the POP server 10 from the wireless unit 64. The execution demand includes the POP ID designated in Act 1. The execution demand wirelessly transmitted through the wireless unit 64 is received with the access point 40, and is further transmitted to the POP server 10 through the network 50.

As described above, the processor 11 waits for reception of a command from the user terminal 60 in Act 21 in FIG. 9. If the command received from the user terminal 60 is the execution demand (YES in Act 26), the processor 11 controls the communication interface 15 such that the output job is transmitted to the advertisement output apparatus 30 in Act 29. The output job is generated based on the POP image data of the POP ID included in the execution demand. The output job is transmitted to the advertisement output apparatus 30 through the network 50 from the communication interface 15.

The processor 11 transmitting the output job controls the communication interface 15 such that a completion response is transmitted to the user terminal 60 in Act 30. The completion response is transmitted through the network 50 from the communication interface 15. The completion response is wirelessly transmitted to the user terminal 60 from the access point 40.

Returning to FIG. 8, the processor 61 transmitting the execution demand returns to the processing in Act 12. The processor 61 waits for the response signal. If the completion response is received from the POP server 10 (“COMPLETION” in Act 13), the processor 61 displays the completion information D1 (refer to FIG. 13) on the touch panel 65.

On the other hand, if the non-execution of the output is instructed in Act 16 (NO in Act 16), the processor 61 controls the wireless unit 64 such that the cancellation demand is transmitted to the POP server 10 in Act 18. The cancellation demand is wirelessly transmitted to the POP server 10 from the wireless unit 64. The cancellation demand includes the POP ID designated in Act 1. The cancellation demand wirelessly transmitted through the wireless unit 64 is received with the access point 40, and is further transmitted to the POP server 10 through the network 50.

The processor 11 receiving the cancellation demand from the user terminal 60 executes the processing in Act 27 and Act 28, as described above. Therefore, the output job created based on the POP image data of the POP ID included in the cancellation demand will be deleted from the output buffer if present therein.

The processor 61 of the user terminal 60 transmitting the cancellation demand displays cancellation information D3 (refer to FIG. 13) on the touch panel 65 in Act 19.

FIG. 13 illustrates an example of a screen SC4 on the touch panel 65 on which the cancellation information D3 is displayed. As shown in FIG. 13, an OK button B7 is displayed along with the cancellation information D3 (“OUTPUT JOB IS CANCELED”) on the screen SC4. If the user who wishes to confirm the cancellation information D3 touches the OK button B7, the information processing according to the POP output demand program 72 is ended.

In the POP server 10, the computer including the processor 11 functions as a detecting unit by executing the processing in Act 51, functions as an acquiring unit by executing the processing in Act 53, functions as a comparing unit by executing the processing in Act 54, and functions a control unit by executing the processing in Act 55, Act 58, and Act 59.

The computer also functions as a receiving unit by executing the processing in Act 21, Act 24, and Act 26 and an output unit by executing the processing in Act 29.

According to the POP advertisement creating system 100 of the first embodiment including the POP server 10 as described above, a user can decide whether or not the POP advertisement for which the list price is different from the actual selling price will be output before the POP advertisement is actually output, for example, by being printed. In this case, the actual selling price is not the price at the current time but the price on a scheduled publication date of the POP advertisement. Accordingly, the automated output of a POP advertisement for which the list price does not match the actual selling price on the advertisement date can be prevented.

Further, according to the POP advertisement creating system 100 described above, a warning is provided on the touch panel 65 of the user terminal 60 when the list price of the POP advertisement is different from the actual selling price, and thus, a user who creates the POP advertisement can quickly notice that a POP advertisement for which the advertised list price does not match the actual selling price is going to be output. Moreover, the user can select whether or not to output the POP advertisement with the mismatched list price and thus, the user can still output a POP advertisement with a list price different from actual selling price if there is a need for such a POP advertisement. Otherwise, the user can cancel the output of such POP advertisement.

### Second Embodiment

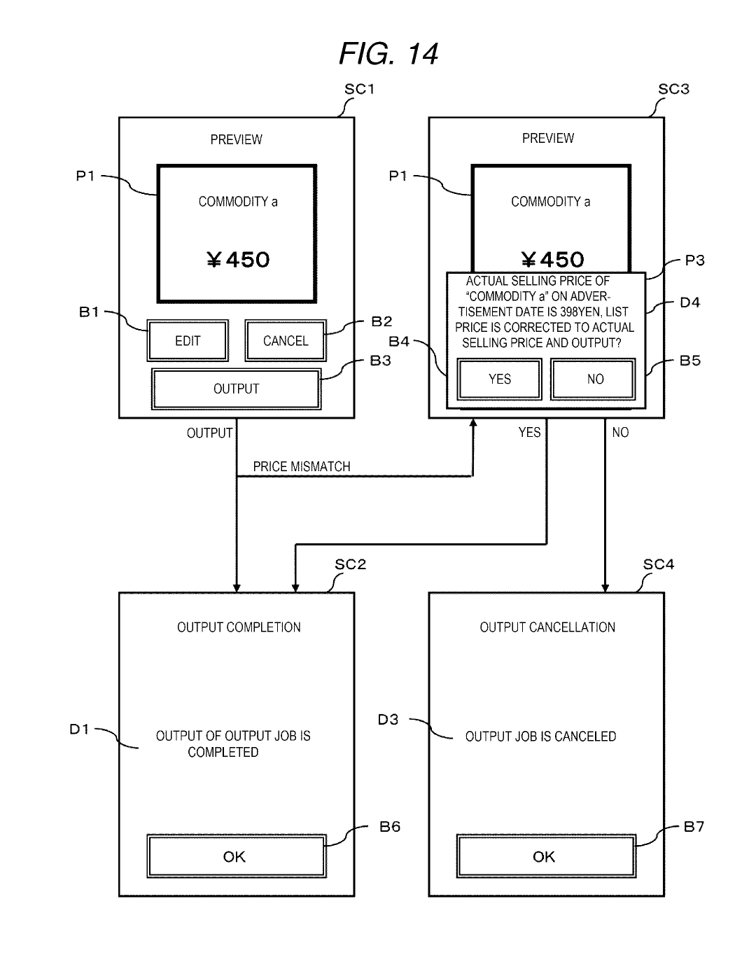

Next, a second embodiment is described with reference to FIG. 14 to FIG. 16. The same reference numerals are assigned to elements or aspects substantially similar to those in the first embodiment, and therefore, the detailed description thereof may be omitted.

In the first embodiment, the user can whether to execute or cancel a particular POP advertisement after a warning has been issued to indicate a discrepancy between the list price in the POP data and the actual selling price of the advertisement target commodity. Specifically, if the “Yes” button B4 on the warning image P2 is touched, the output of the POP advertisement having the mismatched list price is executed or the output of the POP advertisement is canceled if the “No” button B5 is touched. According to the second embodiment, the user can select to output the POP advertisement with a change in the list price to the actual selling price or cancel the output entirely after the warning has been issued due to a discrepancy between the list price in the POP data and the actual selling price of the advertisement target commodity.

FIG. 14 is a screen transition example of the user terminal 60 including a warning image P3 in the second embodiment. In the warning image P3, the content of information D4 including the actual selling price (398 yen) is different, in comparison with the warning image P2 of the first embodiment. In the first embodiment, the information D2 indicates that the “Actual selling price of ‘COMMODITY a’ on advertisement date is 398 YEN.” And further asks whether a POP advertisement with list price (i.e., the uncorrected list price) is to be output. In the second embodiment, the information D4 states that the “Actual selling price of ‘COMMODITY a’ on advertisement date is 398 yen.” But further asks whether a POP advertisement with the actual selling price (i.e., with a list price corrected to the actual selling price) should be output. The contents of the information D2 and D4 are not limited to the examples described above. The content may be composed in any manner for the first embodiment as long as the user can understand that the POP advertisement will be output with the uncorrected list price (i.e., the list price as set by the user in generating the POP advertisement even if not presently matching the actual selling price as extracted from selling price master table 21 or otherwise), and for the second embodiment as long as the user can understand that the POP advertisement will be output with the corrected list price (i.e. the list price as changed to match the actual selling price as extracted from the commodity master table 21 or otherwise).

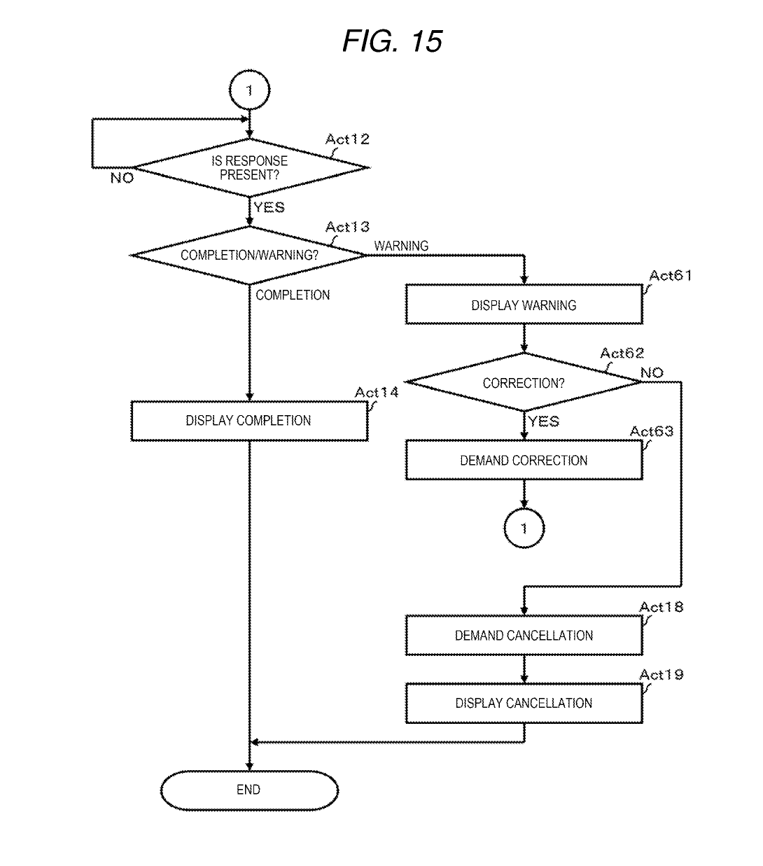

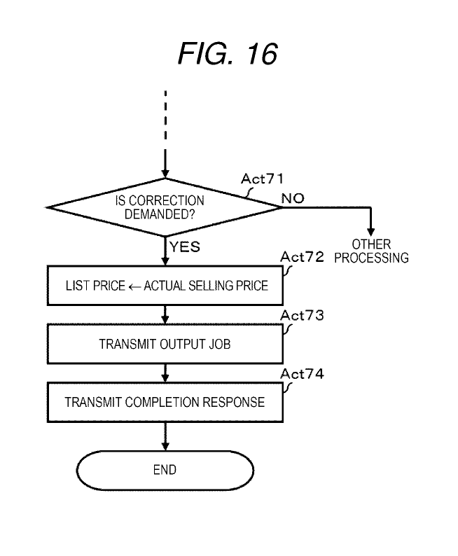

FIG. 15 is a flowchart illustrating a processing procedure executed by the processor 61 of the user terminal 60 according to the second embodiment. The processing procedure in FIG. 15 is similar to that in FIG. 8 in the first embodiment. FIG. 16 is a flowchart illustrating a processing procedure executed by the processor 11 of the POP server 10 according to the second embodiment. The processing procedure in FIG. 16 can be considered similar to “other processing” in FIG. 9 for the first embodiment.

The processor 61 transmitting the output demand waits for the response signal in Act 12. If the response signal is received from the POP server 10 (YES in Act 12), the processor 11 identifies whether the response signal is a completion response or a warning response in Act 13. If the response signal is a completion response (“COMPLETION” in Act 13), the processor 61 displays the completion information D1 (refer to FIG. 14) on the touch panel 65 in Act 14.

On the other hand, if the response signal from the POP server 10 is a warning response (“WARNING” in Act 13), the processor 61 displays the warning image P3 (refer to FIG. 14) on the touch panel 65 in Act 61. The processor 61 confirms whether or not an execution of a correction is instructed in Act 16. If it is detected that the “Yes” button B4 on the warning image P3 is touched, the processor 61 determines that the correction has been instructed. If it is detected that the “No” button B5 is touched, the processor 61 determines that the non-execution of the correction has been instructed.

If the correction is instructed (YES in Act 62), the processor 61 controls the wireless unit 64 such that a correction demand is transmitted to the POP server 10 in Act 63. The correction demand is wirelessly transmitted to the POP server 10 from the wireless unit 64. The correction demand includes the POP ID designated in Act 1. The correction demand wirelessly transmitted through the wireless unit 64 is received with the access point 40, and is further transmitted to the POP server 10 through the network 50.

As described above, the processor 11 waits for the reception of commands from the user terminal 60 in Act 21 in FIG. 9. If the command received from the user terminal 60 is a correction demand (YES in Act 71 in FIG. 16), the processor 11 corrects the list price in the output job to the actual selling price (as acquired by the processing in Act 53 of FIG. 12) in Act 72. Thereafter, the processor 11 controls the communication interface 15 such that the output job is transmitted to the advertisement output apparatus 30 in Act 73. The output job is transmitted to the advertisement output apparatus 30 through the network 50 from the communication interface 15.

The processor 11 transmitting the output job controls the communication interface 15 such that the completion response is transmitted to the user terminal 60 in Act 74. The completion response is transmitted through the network 50 from the communication interface 15. The completion response is wirelessly transmitted to the user terminal 60 from the access point 40.

Returning to FIG. 15, the processor 61 transmitting the correction demand returns to the processing in Act 12. The processor 61 waits for the response signal. If the completion response is received from the POP server 10 (“COMPLETION” in Act 13), the processor 61 displays the completion information D1 (refer to FIG. 14) on the touch panel 65.

On the other hand, if the non-execution of the output is instructed in Act 62 (NO in Act 62), the processor 61 controls the wireless unit 64 such that the cancellation demand is transmitted to the POP server 10 in Act 18. The cancellation demand is wirelessly transmitted to the POP server 10 from the wireless unit 64. The processor 61 transmitting the cancellation demand displays the cancellation information D3 (refer to FIG. 14) on the touch panel 65 in Act 19.

In the POP server 10, the processor 11 realizes the functions of a correcting unit by executing the processing in Act 71 and Act 72, and realizes the functions of the output unit by executing the processing in Act 73.

Therefore, according to the POP advertisement creating system of the second embodiment, if the list price is different from the actual selling price, a POP advertisement in which the list price is corrected to the actual selling price can be output by a simple operation.

In the above embodiments, a data processing apparatus capable of preventing a medium on which the list price is different from the actual selling price from being output is described, but the embodiments described herein are not limited thereto.

For example, in each of the embodiments described above, the store server 20 includes the price master file 21, but the POP server 10 may itself include the price master file 21 as a modification.

In the example embodiments described above, a case in which the user terminal 60 is connected to the POP server 10 by the wireless communication through the access point 40 was described, but the user terminal 60 may be connected to the POP server 10 by connecting the user terminal 60 directly to the network 50. Further, data communication may be performed between the user terminal 60 and the POP server 10 by utilizing an internet connection via LIE® technology, near field communication (NFC) using Bluetooth®, or the like.

Furthermore, in each of the embodiments described above, a case in which the POP server 10 of the POP advertisement creating system 100 utilizing pre-established templates acts as a data processing apparatus, but data processing apparatus is not limited to a POP server 10. For example, a separate detecting unit may be provided to detect or confirm display data including commodity identification information (e.g., a product name) and a selling price for the commodity to be displayed on a medium even if the POP advertisement is generated without utilizing a pre-established template. The detecting unit may detect the display data including the identification information of the commodity and the list price as a selling price of the commodity displayed on the medium, from a digital leaflet brochure which is electronically generated. The display data on the medium is not necessarily limited to the POP data. The display data may be display data other than a POP advertisement. For example, when a proposal document for a travel plan (travel itinerary) is printed to issue a brochure including the travel plan for a travel agency or the like, the travel cost can be checked before the presentation to confirm whether or not the actual selling price (actual cost) is the same as the list price (estimated cost) on the brochure. Therefore, a staff in charge of the presentation may decide print of the proposal document in accordance with a result of the comparison.

A transfer of the data processing apparatus is generally performed in a state in which the relevant program is stored in the main memory 12 or the auxiliary storage device 13. However, transfers are not limited thereto, and transfers may be performed in which the program is not already stored in the main memory 12 or the auxiliary storage device 13. In this case, the program or the like can be transferred separately from the data processing apparatus and as such may be subsequently written in to the data processing apparatus in accordance with ab operation of the user or the like, from a writable storage device which is included in the data processing apparatus. It is also possible to perform the transfer of the program by recording the program on a removable recording medium or by the communication through a network. The recording medium may be in any format as long as it is possible to hold the program and then read the program for loading/storing on the data processing apparatus. Such a non-transitory computer readable medium may be a recording medium such as a CD-ROM, a memory card, or the like. Various functions obtained by installing or downloading the program may be realized in cooperation with an internal operating system (OS) or the like of the data processing apparatus.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A point-of-purchase advertisement system comprising a storage device, a user terminal, and a central server communicating with each other over a computer network, wherein
the storage device maintains a selling price master list including a selling price associated with a commodity identification code;
the user terminal includes a display screen and a first processor configured to generate a point-of-purchase advertisement including a commodity and a display price;
the central server includes a second processor that is configured to:
detect identification information for the commodity in the point-of-purchase advertisement generated at the user terminal;
detect the display price for the commodity in the point-of-purchase advertisement;
extract a selling price for the commodity from the selling price master list using the detected identification information for the commodity;
compare the extracted selling price to the detected display price; and
cause the display device of the user terminal to display a screen indicating the display price and selling price differ when the comparison so indicates and requesting additional user input before permitting output of the point-of-purchase advertisement to an advertisement output device.

2. The point-of-purchase advertisement system according to claim 1, wherein the requesting of the additional user input permits a user of the user terminal to select whether the point-of-purchase advertisement is output with the display price differing from the selling price.

3. The point-of-purchase advertisement system according to claim 1, wherein the requesting of the additional user input permits a user of the user terminal to select whether the point-of-purchase advertisement is output with the display price changed to the selling price.

4. The point-of-purchase advertisement system according to claim 1, wherein the advertisement output device is a printer.

5. The point-of-purchase advertisement system according to claim 1, wherein the advertisement output device is an electronic signage display.

6. The point-of-purchase advertisement system according to claim 1, wherein the storage device is part of a store server.

7. The point-of-purchase advertisement system according to claim 1, wherein the second processor is further configured to delete the point-of-purchase advertisement from an output buffer of the advertisement output device when the user cancels output of the point-of-purchase advertisement in response to the displaying of the screen indicating the display price and selling price differ.

8. The point-of-purchase advertisement system according to claim 1, wherein
the selling price master list associates the selling price with a date, and
the second processor is further configured to extract the selling price for the selling price master list according to an output date setting for the point-of-purchase advertisement.

9. A point-of-purchase advertisement generation method, comprising:
detecting identification information for a commodity in data to be displayed in a point-of-purchase advertisement;
detecting a display price for the commodity in the data to be displayed in the point-of-purchase advertisement;
extracting a selling price for the commodity from a commodity master table using the detected identification information for the commodity;
comparing the extracted selling price to the detected display price; and
controlling a display device to display a screen indicating the display price and selling price differ when the comparison so indicates and requesting additional user input before permitting output of the point-of-purchase advertisement to an advertisement output device.

10. The point-of-purchase advertisement generation method according to claim 9, wherein the requesting of the additional user input permits the user to select whether the point-of-purchase advertisement is output with the display price differing from the selling price.

11. The point-of-purchase advertisement generation method according to claim 9, wherein the requesting of the additional user input permits the user to select whether the point-of-purchase advertisement is output with the display price changed to the selling price.

12. A data processing apparatus, comprising:
a processor configured to:
detect identification information for a commodity in data to be displayed in a point-of-purchase advertisement;
detect a display price for the commodity in the data to be displayed in the point-of-purchase advertisement;
extract a selling price for the commodity from a commodity master table using the detected identification information for the commodity;
compare the extracted selling price to the detected display price; and
control a display device to display a screen indicating the display price and selling price differ when the comparison so indicates and requesting additional user input before permitting output of the point-of-purchase advertisement to an advertisement output device.

13. The data processing apparatus according to claim 12, wherein the requesting of the additional user input permits the user to select whether the point-of-purchase advertisement is output with the display price differing from the selling price.

14. The data processing apparatus according to claim 12, wherein the requesting of the additional user input permits the user to select whether the point-of-purchase advertisement is output with the display price changed to the selling price.

15. The data processing apparatus according to claim 12, wherein the advertisement output device is one of printer or an electronic signage display.

16. The data processing apparatus according to claim 12, wherein the processor is further configured to delete the point-of-purchase advertisement from an output buffer of the advertisement output device when the user cancels output of the point-of-purchase advertisement in response to the displaying of the screen indicating the display price and selling price differ.

17. The data processing apparatus according to claim 12, further comprising:
a communication module configured to perform a data communication with a user terminal across a network, wherein
the display device is on the user terminal.

18. The data processing apparatus according to claim 17, wherein the processor is further configured to:
change the display price to the selling price if the additional user input received via the user terminal is an instruction to the output the point-of-purchase advertisement is with the display price changed to the selling price.

19. The data processing apparatus according to claim 12, wherein the processor is disposed in a point-of-purchase advertisement server and the display device is a part of a user terminal connected to the point-of-purchase advertisement server via a network connection.

20. The data processing apparatus according to claim 12, wherein
the commodity master table associates the selling price with a date, and
the processor is further configured to extract the selling price for the commodity from the commodity master table according to an output date setting for the point-of-purchase advertisement.
